(19) United States
(12) Patent Application Publication
(10) Pub. No.: US 2008/0027927 A1
(43) Pub. Date: Jan. 31, 2008

(54) Retracement data processing method and apparatus

(75) Inventor: Takanori Ugai, Kawasaki (JP)

Correspondence Address: Patrick G. Burns;GREER, BURNS & CRAIN, LTD., Suite 2500, 300 South Wacker Drive, Chicago, IL, 60606, US

(73) Assignee: FUJITSU LIMITED

(21) Appl. No.: 11/546,093

(22) Filed: Oct. 11, 2006

(30) Foreign Application Priority Data
Jul. 27, 2006 (JP) 2006-204277

(51) Int. Cl. G06F 17/30

(52) U.S. Cl. 707/5

(57) ABSTRACT

This invention is to automatically carry out the retracement of the knowledge. Therefore, this method is executed by a computer having a retracement data storage storing a target type of a past project, data concerning a scale of the past project, a specific phase of the past project, data concerning a problem in the specific phase of the past project, and data concerning an action against a problem in the specific phase of the past project. Then, this method comprises: obtaining project data including a target type of a project, data concerning a scale of the project, and a pertinent phase of the project; calculating an overall similarity for the retracement data of each past project, which is stored in the retracement data storage, by using a first similarity against the target type of the project, a second similarity against the data concerning the scale of the project, and a third similarity against the phase of the project; reading out, based on the overall similarity, from the retracement data storage, the data concerning the problem in the specific phase of the past project or the like.

### TECHNICAL FIELD OF THE INVENTION

This invention relates to a technique to support studies of knowledge about various projects such as a system development, construction, and hardware development, and accumulate the knowledge.

### BACKGROUND OF THE INVENTION

Conventionally, a research is carried out in which an outline of a project is inputted to indicate an assumed risk. However, even if the risk is indicated, when executers themselves of the project do not carry out studies or do not take them root into themselves, the same mistake is repeated. In addition, a database storing failed cases is created, and the keyword search of the database can be carried out, for example. However, the cases are not arranged and provided so that the executers can materially carry out studies.

For example, JP-A-2001-265580 discloses a review supporting technique capable of preventing the omission of check items and supporting a review from the designing/preparing stage to the post processing, efficiently and precisely. Specifically, a review supporting system has means for inputting information peculiar to a project, which is composed of a project name of the project, a development purpose, development items and function outline, the type of the system/product, a development scale and development man-month, into a database of a client computer; means for searching and extracting a similar project from past projects registered in a database of a server computer based on the inputted information; means for searching and determining check items common to overall software products for each step and check items considered for each type from the characteristic of the system and/or product from the database of the server computer based on the further inputted information; means for extracting check items concerning the system and/or the product type from information of the similar project; means for determining unique check items for checking consistency between the input and the output or the like for each step unit of the project, and unifying all check items until this to input unified check items into the database of the client computer; means for inputting a result of a review by using a list of the unified check items into the database of the client computer; means for searching a problem point extracted as a result of the review from the information of the similar project, and utilizing the result for determination of a correction/measure method; and means for inputting final information that the problem points and the like are resolved into the database of the client computer, and further registering it into the database of the server computer. However, there is no disclosure of a specific method for searching and extracting the similar projects.

For example, in order to study the past failures or the like and make them take root, it is said that the retracement is required. However, the self-examination is difficult. That is, there are problems in which he or she cannot find out what should be reflect, he or she forgets the past reflection, and there is no awareness of the solution or the like because he or she does not know what other people other than himself or herself carry out.

Because any appropriate retracement cannot be easily carried out by the conventional art, there are problems that the studies cannot be encouraged and taken root for the executors of the project.

### SUMMARY OF THE INVENTION

Therefore, an object of this invention is to provide a new technique to automatically carry out the retracement of the knowledge.

In addition, another object of this invention is to provide a technique to prevent the repeat of failures by appropriately carrying out the retracement of the knowledge.

Furthermore, still another object of this invention is to provide a technique to support accumulation of the knowledge.

A retracement data processing method according to this invention is executed by a computer having a storage unit and a retracement data storage storing a target type of a past project (e.g. a type of business of a company or the like using a system in a case of a system development project, a type of model or function in a case of a hardware development project, a type of building in a case of an architectural project or the like), data concerning a scale of the past project, a specific phase of the past project, data concerning a problem in the specific phase of the past project, and data concerning an action (e.g. a solution, a settlement plan, a remedy, an improvement plan or the like) against a problem in the specific phase of the past project. Then, the retracement data processing method comprises: obtaining project data including a target type of a project, data concerning a scale of the project, and a pertinent phase (e.g. identification information including the name of the phase or the like) of the project, and storing the data into the storage unit; calculating an overall similarity (e.g. a similarity in an embodiment of this invention) for the retracement data of each past project, which is stored in the retracement data storage, by using a first similarity against the target type of the project, a second similarity against the data concerning the scale of the project, and a third similarity against the phase of the project, which are stored in the storage unit, and storing the calculated overall similarity into the storage unit; reading out, based on the overall similarity stored in the storage unit, from the retracement data storage, the data concerning the problem in the specific phase of the past project, or the data concerning the problem of the specific phase of the past project and the data concerning the action against the problem in the specific phase of the past project.

Effective data of the past project for the retracement is automatically extracted based on the first similarity against the target type of the project, the second similarity against the data concerning the scale of the project, and the third similarity against the pertinent phase of the project, which are said to experimentally be important. By carrying out such a processing, the retracement can be effectively carried out, and the repeat of the failure can be prevented.

In addition, the retracement data processing method may further comprise: obtaining data concerning a problem in the pertinent phase of the project, and storing the data into the storage unit; calculating a fourth similarity against the data concerning the problem in the pertinent phase of the project, which is stored in the storage unit, for the retracement data of the past project, which is stored in the retracement data storage, and modifying the overall similarity stored in the storage unit by using the fourth similarity; and reading out, based on the modified overall similarity, from the retracement data storage, the data concerning the action against the problem in the specific phase of the past project, or the data concerning the action against the problem in the specific phase of the past project and the data concerning the problem in the specific phase of the past project. It becomes possible to study measures or the like against the problem (e.g. an issue, a question or the like) from appropriate past cases. Incidentally, the overall similarity may be re-calculated, not modified.

The retracement data processing method may further include: obtaining data concerning an action against a problem in the pertinent phase of the project, and storing the data into the storage unit; calculating a fifth similarity against the data concerning the action against the problem in the pertinent phase of the project for the retracement of the past project, which is stored in the retracement data storage, and modifying the overall similarity stored in the storage unit by using the fifth similarity; reading out, based on the modified overall similarity, from the retracement data storage, the data concerning the action against the problem in the specific phase of the past project, or the data concerning the action against the problem in the specific phase of the past project and the data concerning the problem in the specific phase of the past project. It becomes possible to efficiently study by narrowing the measures against the problem or the like. Incidentally, the overall similarity can be re-calculated, not modified.

In addition, the retracement data processing method may further include: obtaining at least one of data concerning a delay of a schedule, data concerning a package program utilized in a system development, data concerning a hardware utilized in the system development, and data concerning an operating system utilized in the system development, and storing the obtained data into the storage unit. At that time, in the calculating the overall similarity, at least one of a similarity against the data concerning the delay of the schedule, a similarity against the data concerning the package program utilized in the system development, a similarity against the data concerning the hardware utilized in the system development, and a similarity against the data concerning the operating system utilized in the system development is further utilized to calculate the overall similarity. For example, it is effective for the system development.

Furthermore, the second similarity against the data concerning the scale of the project and the third similarity against the pertinent phase of the project are identified by judging whether or not a class corresponding to each of the data concerning the scale of the project and the pertinent phase of the project coincides with a predetermined class.

In addition, the aforementioned modifying by using the fourth similarity may include: generating a first vector concerning words appeared in the data concerning the problem in the pertinent phase of the project; generating a second vector concerning words appeared in the data concerning the problem in the specific phase of the past project; and calculating a similarity based on an inner-product of the first and second vectors by using the first and second generated vectors. For example, it is based on the Term Frequency-Inverse Document Frequency (TF-IDF) method.

Similarly, the aforementioned modifying by using the fifth similarity may comprises: generating a third vector concerning words appeared in the data concerning the action against the problem in the pertinent phase of the project; generating a fourth vector concerning words appeared in the data concerning the action against the problem in the specific phase of the past project; and calculating a similarity based on an inner-product of the third and fourth vectors by using the third and fourth generated vectors.

Furthermore, the retracement data processing method may further comprise: storing obtained data into the retracement data storage. By carrying out such a processing, in addition to the studies, further the knowledge can be accumulated.

Incidentally, it is possible to create a program for causing a computer to execute this method according to the present invention. The program is stored into a storage medium or a storage device such as, for example, a flexible disk, a CD-ROM, a magneto-optical disk, a semiconductor memory, or a hard disk. In addition, the program may be distributed as digital signals over a network in some cases. Data under processing is temporarily stored in the storage device such as a computer memory.

### BRIEF DESCRIPTION OF THE DRAWINGS

FIG. 1 is a diagram showing a system outline according to an embodiment of this invention;

FIG. 2 is a diagram showing an example of data stored in a progress management DB;

FIG. 3 is a diagram showing an example of data stored in a retracement DB;

FIG. 4 is a diagram showing a main processing flow in the embodiment of this invention;

FIG. 5 is a diagram showing a processing flow of a first similar case search processing;

FIG. 6 is a diagram showing a processing flow of the first similar case search processing;

FIG. 7 is a diagram showing an example of a similarity list;

FIG. 8 is a diagram showing a first screen example;

FIG. 9 is a diagram showing a processing flow of a second similar case search processing;

FIG. 10 is a diagram showing a second screen example;

FIG. 11 is a diagram showing a processing flow of a third similar case search processing;

FIG. 12 is a diagram showing the main processing flow in the embodiment of this invention;

FIG. 13 is a diagram showing a third screen example;

FIG. 14 is a diagram showing a fourth screen example;

FIG. 15 is a diagram showing a fifth screen example; and

FIG. 16 is a functional block diagram of a computer.

### DETAILED DESCRIPTION OF THE PREFERRED EMBODIMENTS

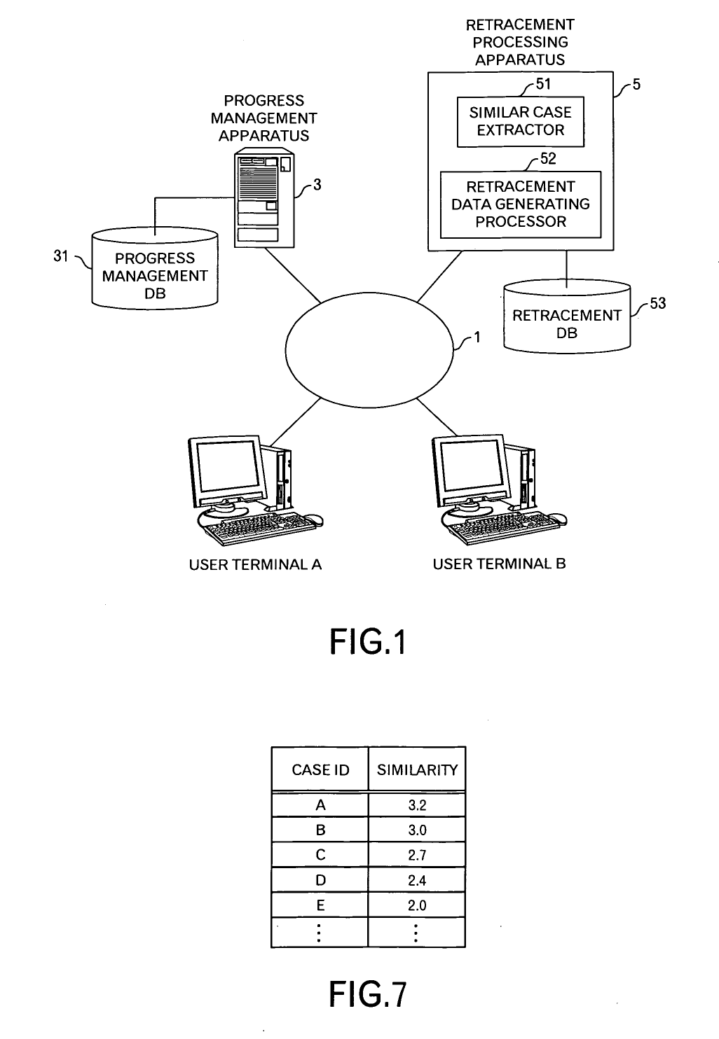

FIG. 1 shows a system outline according to one embodiment of this invention. Hereinafter, an example in a system development such as a system integration will be described. For example, a network 1 such as a Local Area Network (LAN) is connected to a progress management apparatus 3 that manages a progress management database (DB) 31 storing data for the progress management of projects or the like (including data of the Work Breakdown Structure (WBS) or the like) a retracement processing apparatus 5 that carries out a main processing in this embodiment, and plural user terminal (in FIG. 1, a user terminal A, and a user terminal B).

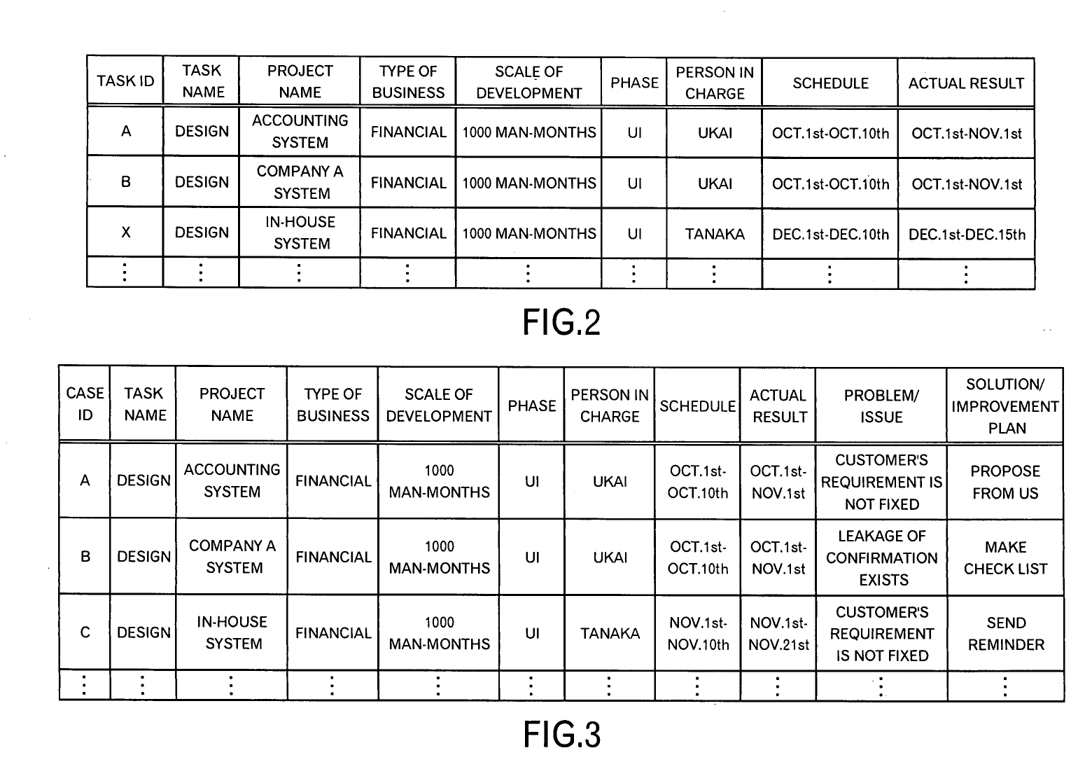

The progress management apparatus 3 and the progress management DB 31 are conventionally utilized, and the details of them are omitted. However, for example, data as shown in FIG. 2 is held. In the example in FIG. 2, a table stores a task ID, a task name, a project name, a target type of business of the project, a development scale, a pertinent phase, a person in charge of the project, a schedule of the pertinent phase, and an actual result of the pertinent phase. For example, the person in charge of the project operates the user terminal A or the like to transmit the aforementioned data to the progress management apparatus 3, and the progress management apparatus 3 receives the aforementioned data from the user terminal A or the like and stores the data into the progress management DB 31. In addition, the person in charge of the project operates the user terminal A or the like to request data of the project of which he or she is in charge, for example, when it is necessary, and the progress management apparatus 3 reads out data from the progress management DB 31 in response to the request, and transmits the read data to the user terminal A or the like. The user terminal A or the like receives data relating to the request from the progress management apparatus 3, and displays it on the display device.

Incidentally, although not shown, data concerning a name or type of the utilized package program, a hardware configuration in a component level, and a name or type of the Operating System (OS) may be stored in the progress management DB 31.

Moreover, the retracement processing apparatus 5 has a similar case extractor 51 that extracts data appropriate for causing the user to carry out the retracement (also called a similar case) from a retracement DB 53, and a retracement data generating processor 52 that obtains necessary task data from the progress management apparatus 3 or the user terminal, transmits data extracted by the similar case extractor 51 as an interface with the user, and registers, as the interface with the user, an issue/problem, a solution/improvement plan and the like, which are received from the user terminal, into the retracement DB 53.

For example, data as shown in FIG. 3 is stored in the retracement DB 53. In the example in FIG. 3, the table stores a case ID, a task name, a project name, a type of business, a development scale, a phase, a person in charge of the project, a schedule of the phase, an actual result of the phase, a problem/issue of the phase, and a solution/improvement plan. Incidentally, although not shown, data concerning a name or type of the utilized package program, a hardware configuration in a component level, a name or type of the OS and the like may also be stored in the retracement DB 53.

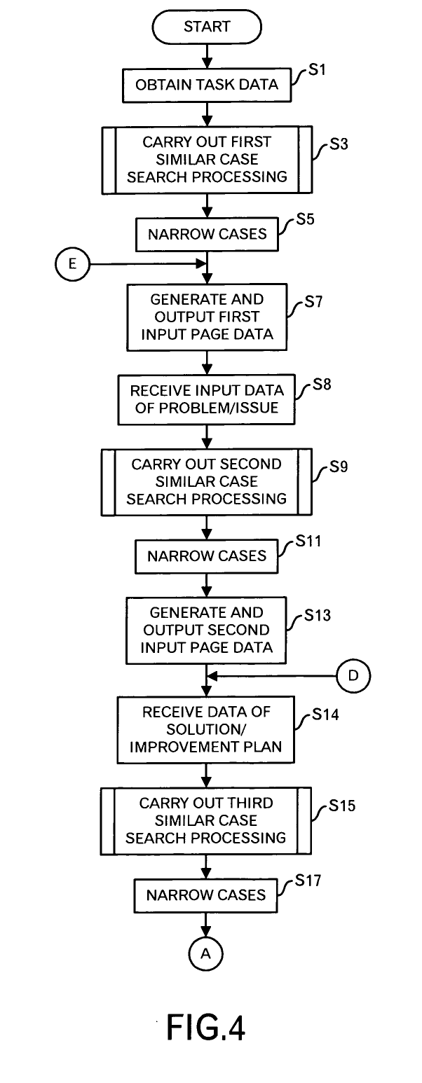

Next, a processing of the retracement processing apparatus 5 will be explained by using FIGS. 4 to 15. First, the retracement data generating processor 52 of the retracement processing apparatus 5 obtains, for example, a task ID from the user terminal A operated by a user A, for example, and requests the task data of the task ID to the progress management apparatus 3. The progress management apparatus 3 searches the progress management DB 31 by using the task ID or the like, reads out data (i.e. task data) of the corresponding record, and transmits it to the retracement processing apparatus 5. Incidentally, based on another data other than the task ID (e.g. a combination of a name of the person in charge of the project and a project name), the search may be carried out. The retracement data generating processor 52 of the retracement processing apparatus 5 obtains the task data by receiving it from the progress management apparatus 3 (step S1). By requesting the input for the user, the task data may be obtained from the user terminal A.

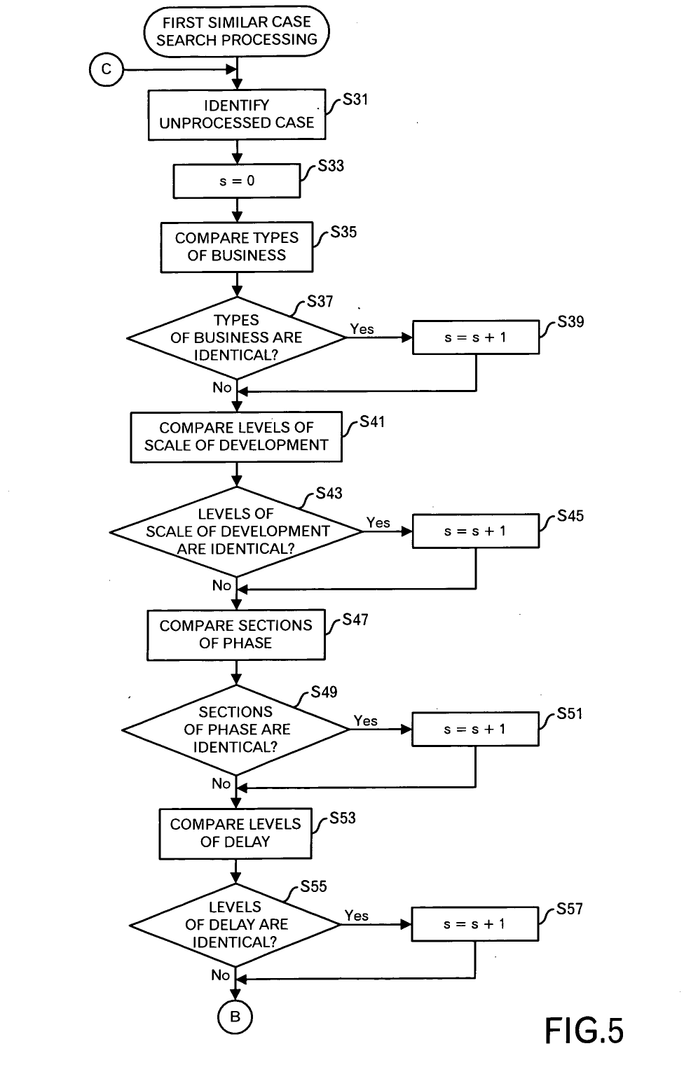

Next, the retracement data generating processor 52 outputs the obtained task data to the similar case extractor 51, and the similar case extractor 51 carries out a first similar case search processing based on the task data (step S3). The first similar case search processing will be explained by using FIGS. 5 to 7.

First, the similar case extractor 51 identifies one unprocessed case from the retracement DB 53 (step S31). Then, it initializes a similarity s to 0 (step S33). Then, it compares the type of business in the task data with the type of business in the identified case (step S35). When they coincides each other (step S37: Yes route), it increments the similarity s by 1 as the similarity of the type of business is 1 (step S39). Then, the processing shifts to step S41.

When the types of business do not coincide each other (step S37: No route), or after the step S39, it compares a level of the development scale in the task data with a level of the development scale in the identified case (step S41). For example, a level (also called a stage) equal to or less than 100 man-months, a level greater than 100 man-months and less than 1000 man-months, and a level equal to or greater than 1000 man-months are classified, and it is judged whether or not the levels are identical. When the levels of the development levels are identical (step S43: Yes route), it increments the similarity s by 1 as the similarity of the development scale is 1 (step S45). Then, the processing shifts to step S47.

When the levels of the development scale are not identical each other (step S43: No route), or after the step S45, it compares a phase section in the task data with a phase section in the identified case (step S47). For example, the phase is classified into a “pre” section, “after” section, and “maintenance” section, and it is judged whether or not the sections are identical each other. When the phase sections are identical each other (step S49: Yes route), it increments the similarity s by 1 as the similarity of the phase is 1 (step S51). Then, the processing shifts to step S53.

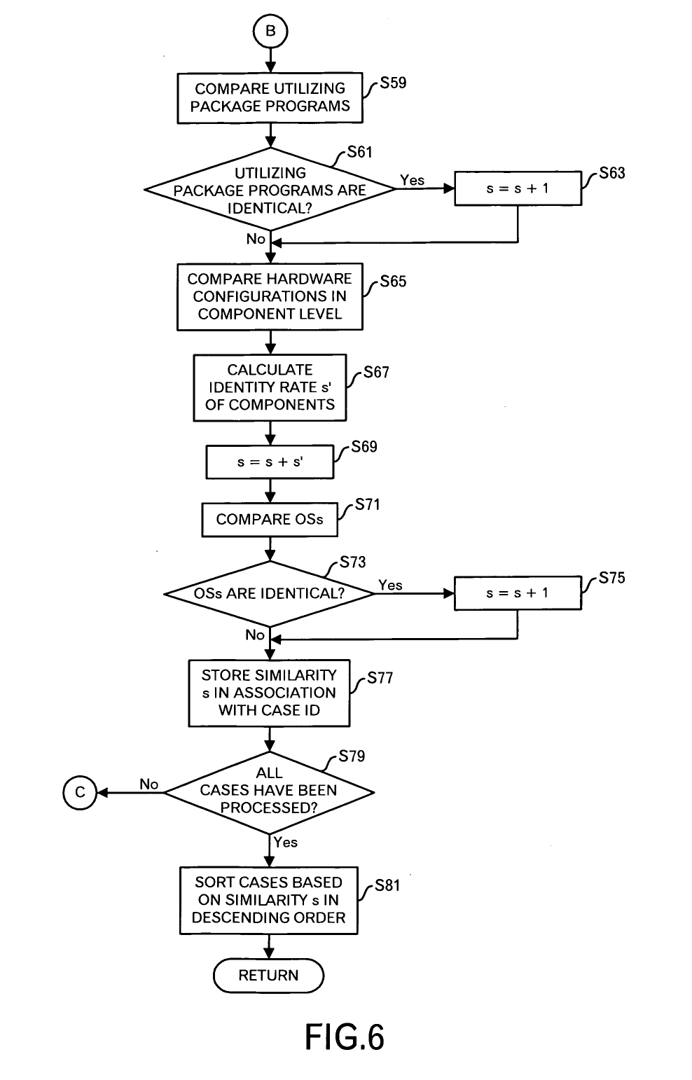

When the phase sections are not identical each other (step S49: No route), or after the step S51, it compares a level of the delay in the task data with a level of the delay in the identified case (step S53). First, it calculates the number of delay days that is a difference between the schedule (i.e. plan) and the actual result in the task data, and calculates the number of delay days that is a difference between the schedule (i.e. plan) and the actual result in the identified case, and stores them into a storage device such as a main memory. Then, the number of delay days are classified into a level of 3 days or less in the delay, a level of 4 days to 9 days in the delay, and a level of 10 days or more, and it is judged whether or not the levels of the delay are identical each other. When the levels of the delay are identical (step S55: Yes route), it increments the similarity s by 1 as the similarity of the delay is 1 (step S57). Then, the processing shifts to a processing of FIG. 6. When the levels of the delay are not identical (step S55: No route), the processing also shifts to the processing of FIG. 6.

Next, it compares a utilizing package program in the task data with a utilizing package program in the identified case (step S59). When the utilizing package programs are identical (step S61: Yes route), it increments the similarity s by 1 as a similarity of the utilizing package program is 1 (step S63). Then, the processing shifts to step S65.

When the utilizing package programs are not identical each other (step S61: No route), or after the step S63, it compares the hardware configuration in the task data with the hardware configuration in the identified case in the component level (step S65) For example, it judges whether or not the types of the CPU are identical each other, whether or not the types of the hard disk are identical each other, and the like. Then, it calculates an identity rate s′ of the components as a similarity in the hardware configuration by dividing the number of identical components by the total number of components, and stores the similarity s′ into the storage device such as a main memory (step S67). Then, it update the similarity s by s=s+s′ (step S69).

Furthermore, it compares the OS in the task data with the OS in the identified case (step S71). When the OSs are identical (step S73: Yes route), it increments the similarity s by 1 as the similarity of the OS is 1 (step S75). Then, the processing shifts to step S77.

When the OSs are not identical each other (step S73: No route) or after the step S75, it stores the similarity s into the storage device such as a main memory in association with the case ID (step S77). Then, it judges whether or not all of the cases in the retracement DB 53 have been processed (step S79). When there is an unprocessed case, the processing returns to the step S31. On the other hand, when all of the cases in the retracement DB 53 have been processed, it sorts the cases based on the similarity s in descending order (step S81). Then, the processing returns to the original processing.

For example, data as shown in FIG. 7 is obtained by the step S81. That is, the calculated similarity s is stored in association with the case ID, and the cases are arranged based on the similarity s in descending order.

Incidentally, when, in FIGS. 5 and 6, comparison is carried out for an item not included in either or both of the task data and the case data, it is judged as being not identical or the similarity “0”.

By carrying out such a processing, it becomes possible to extract cases judged as being similar in the first stage from a list as shown in FIG. 7.

For example, the similar case extractor 51 outputs the list as shown in FIG. 7 to the retracement data generating processor 62.

Then, the retracement data generating processor 52 narrows the cases to top predetermined-number cases from the list as shown in FIG. 7 (step S5), reads out data of corresponding problems/issues from the retracement DB 53 and data of the solutions/improvement plans by using the case IDs of the narrowed cases, and generate the first input page data to transmit the first input page data to the user terminal A, for example (step S7). Incidentally, when the similarities of the last cases among the top predetermined-number cases are the same, it is possible to select them even if the number of cases is greater than the predetermined number. In addition, it is possible to judge based on the value of the similarity, whether or not the case should be adopted. Moreover, only data of the problem/issue may be extracted.

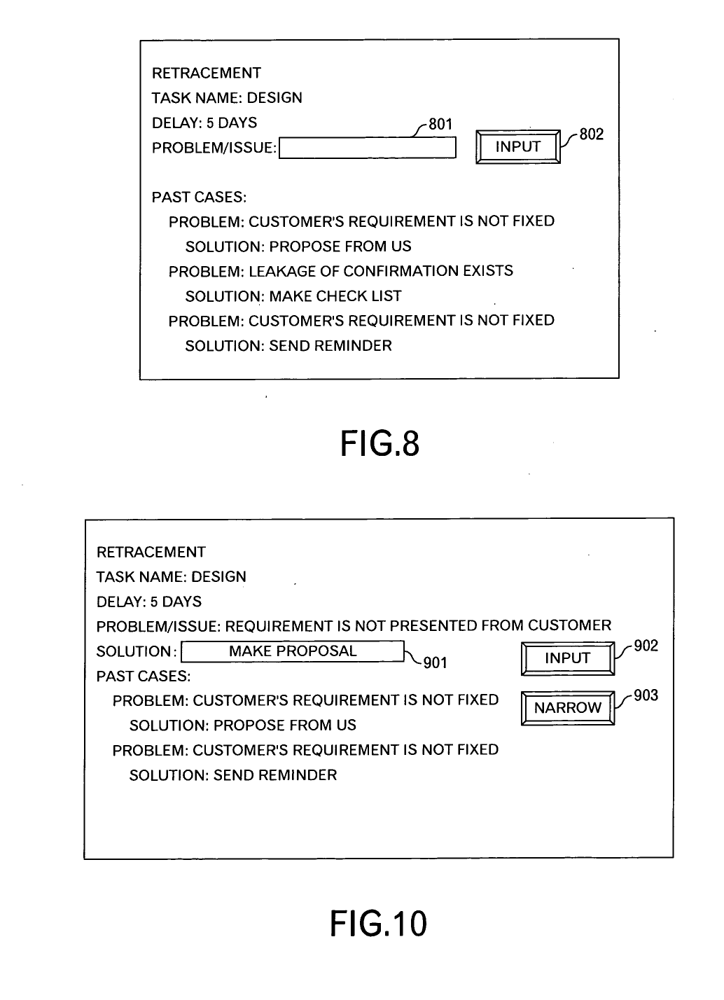

The user terminal A receives the first input page data from the retracement processing apparatus 5, and displays the first input page on the display device. For example, a screen as shown in FIG. 8 is displayed on the display device. In the example of FIG. 8, data whose case IDs of the cases stored in the retracement DB 53 shown in FIG. 3 are A, B and C is identified, and the screen includes the problem/issue and the solution/improvement plan as “past cases”. In addition, an input column 801 of the problem/issue in the task of this time, and an input button 802 are provided in the screen. Here, while the user A refers to the “past cases”, he or she input a problem/issue into the input column 801, and clicks the input button 802 to instruct the user terminal A to transmit the input data to the retracement processing apparatus 5. The user terminal A accepts the input from the user A, and transmits the data concerning the problem/issue to the retracement processing apparatus 5 according to the instruction.

The retracement data generating processor 52 of the retracement processing apparatus 5 receives data concerning the problem/issue from the user terminal A (step S8), and stores the data into the storage device such as a main memory. Then, it output the received data to the similar case extractor 51.

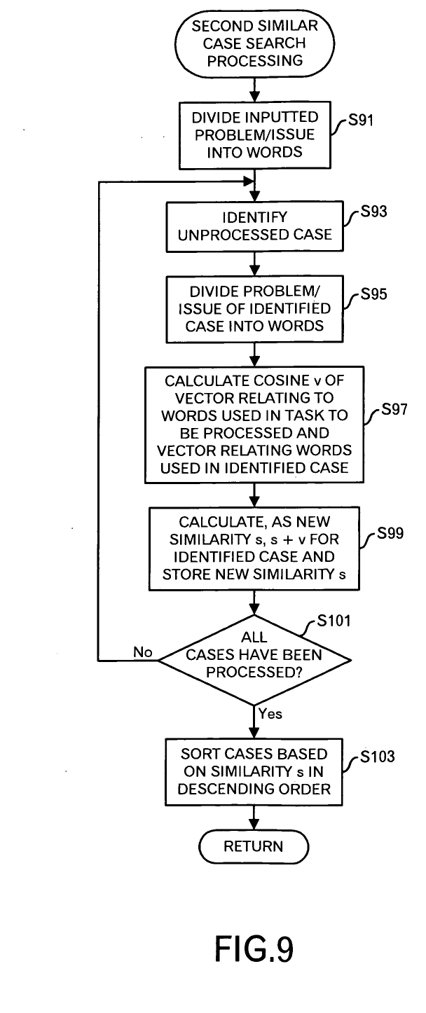

The similar case extractor 51 accepts the data from the retracement data generating processor 52, and carries out a second similar case search processing (step S9). This second similar case search processing will be explained by using FIG. 9.

First, the similar case extractor 51 divides a sentence or sentences of the problem/issue that is the received data into words, and stores them into the storage device such as a main memory (step S91). Then, it identifies one unprocessed case in the retracement DB 53 (step S93). Incidentally, it is possible to simplify the processing, for example, by identifying one unprocessed case in the top 20, for example, of the list as shown in FIG. 7, not an unprocessed case in the retracement DB 53. It is also possible to identify one unprocessed case having the similarity equal to or greater than a predetermined similarity, not top 20 or the like. Incidentally, “20” is mere an example.

Next, it obtains a sentence or sentences of the problem/issue of the identified unprocessed case from the retracement DB 53, divides the sentence or sentences into words, and stores them into the storage device such as a main memory (step S95). Then, it calculates a TF-IDF value for each word with respect to each of the task to be processed and the identified case, generates a vector p of the task to be processed and a vector q of the identified case based on the calculated TF-IDF values, calculates, as a similarity of the problem/issue, a cosine v (=(inner-product of p and q)/|p|/|q|. The value of the cosine is from 0 to 1.) of the vectors p and q, and stores the similarity of the problem/issue into the storage device such as a main memory (step S97).

After that, it calculates, as a new similarity s, a sum (s+v) of the similarity s, which has been calculated for the identified case, and the cosine v, and stores the sum into the list as shown in FIG. 7 (step S99). Then, it judges whether or not all of the cases have been processed (step S101). Also in this case, it is possible to restrictively judge whether or not there is an unprocessed case like in the step S93. When there is an unprocessed case, the processing returns to the step S93. On the other hand, when all of the cases have been processed, it sorts the cases based on the similarity s in descending order (step S103). Although the order is changed, the data as shown in FIG. 7 is obtained.

Thus, as for the past cases, while considering the data of the problem/issue into account, the similarity is calculated. Incidentally, Although, in the second similar case search processing, the result of the first similar case search processing is used to omit the first similar case search processing itself, the second similar case search processing may be carried out in addition to the first similar case search processing, or in addition to the first similar case search processing in which thresholds such as the level and the section are changed.

For example, the similar case extractor 51 outputs the list as shown in FIG. 7 to the retracement data generating processor 52.

Returning to the explanation of FIG. 4, the retracement data generating processor 52 narrows the cases to the top predetermined-number cases from the list as shown in FIG. 7 (step S11) reads out data of the corresponding problems/issues and data of the corresponding solutions/improvement plans from the retracement DB 53 by using the case IDs of the narrowed cases, generate a second input page data by using the read data to transmit the second input page data to the user terminal A, for example (step S13). Incidentally, when the last cases among the top predetermined-number cases have the same value, it is possible to select the cases even if the number of cases is over the predetermined number. In addition, it is possible to judge based on the value of the similarity whether or not the case should be adopted. Moreover, it is possible to extract only the data of the problems/issues or only the data of the solutions/improvement plans.

The user terminal A receives the second input page data from the retracement processing apparatus 5, and displays the second input page on the display device. For example, when “any requirement is not presented from the customer” is inputted in the input column 801 of the screen in FIG. 8, and the input button 802 is clicked, a screen as shown in FIG. 10 is displayed on the display device, for example. In the example of FIG. 10, data whose case IDs of the cases stored in the retracement DB 53 shown in FIG. 3 are A and C is identified in the step S11, and the screen includes their problems/issues and solutions/improvement plans as the “past cases”. In addition, an input column 901 of the problem/issue for this task, an input button 902, and a narrow button 903 are provided on the screen. At this stage, any data is not inputted in the input column 901.

Here, while the user A refers to the “past cases”, he or she inputs the solution/improvement plan (e.g. “make a propose”) into the input column 901, and clicks the input button 902 or the narrow button 903 to instruct the user terminal A to transmit the input data to the retracement processing apparatus 5. The user A accepts the input from the user A, and transmits the data concerning the solution/improvement plan according to the instruction to the retracement processing apparatus 5.

The retracement data generating processor 52 of the retracement processing apparatus 5 receives the data concerning the solution/improvement plan from the user terminal A (step S14), and stores the data into the storage device such as a main memory. Then, it outputs the received data to the similar case extractor 51.

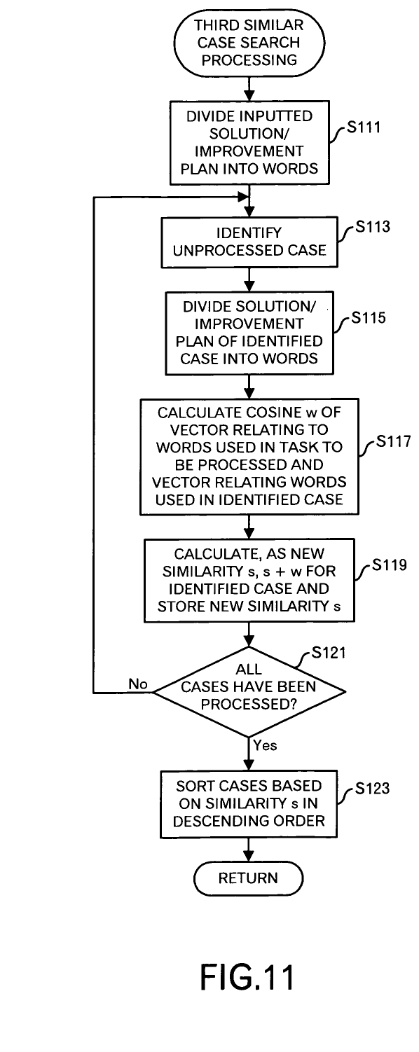

Then, the similar case extractor 51 receives the data from the retracement data generating processor 52, and carries out a third similar case search processing (step S15). This third similar case search processing will be explained by using FIG. 11.

First, the similar case extractor 51 divides a sentence or sentences of the solution/improvement plan that is the received data into words, and stores them into the storage device such as a main memory (step S111). Then, it identifies one unprocessed case in the retracement DB 53 (step S113). Incidentally, it is possible to simplify the processing, for example, by identifying one unprocessed case in the top 20, for example, of the list as shown in FIG. 7, not an unprocessed case in the retracement DB 53. It is also possible to identify one unprocessed case having the similarity equal to or greater than a predetermined similarity, not top 20 or the like. Incidentally, “20” is mere an example.

Next, it obtains a sentence or sentences of the solution/improvement plan of the identified unprocessed case from the retracement DB 53, divides the sentence or sentences into words, and stores them into the storage device such as a main memory (step S115). Then, it calculates a TF-IDF value for each word with respect to each of the task to be processed and the identified case, generates a vector p of the task to be processed and a vector q of the identified case based on the calculated TF-IDF values, calculates, as a similarity of the solution/improvement plan, a cosine w (=(inner-product of p and q)/|p|/|q|. The value of the cosine is from 0 to 1.) of the vectors p and q, and stores the similarity of the solution/improvement plan into the storage device such as a main memory (step S117).

After that, it calculates, as a new similarity s, a sum (s+w) of the similarity s, which has been calculated for the identified case, and the cosine w, and stores the sum into the list as shown in FIG. 7 (step S119). Then, it judges whether or not all of the cases have been processed (step S121). Also in this case, it is possible to restrictively judge whether or not there is an unprocessed case like in the step S113. When there is an unprocessed case, the processing returns to the step S113. On the other hand, when all of the cases have been processed, it sorts the cases based on the similarity s in descending order (step S123). Although the order is changed, the data as shown in FIG. 7 is obtained.

Thus, as for the past cases, while considering the data of the solution/improvement plan into account, the similarity is calculated. Incidentally, although, in the third similar case search processing, the result of the first similar case search processing and the second similar case search processing is used to omit the first and second similar case search processings themselves, the third similar case search processing may be carried out in addition to the first and the second similar case search processing, or in addition to the first similar case search processing and the second similar case search processing in which thresholds such as the level and the section are changed.

For example, the similar case extractor 51 outputs the list as shown in FIG. 7 to the retracement data generating processor 52.

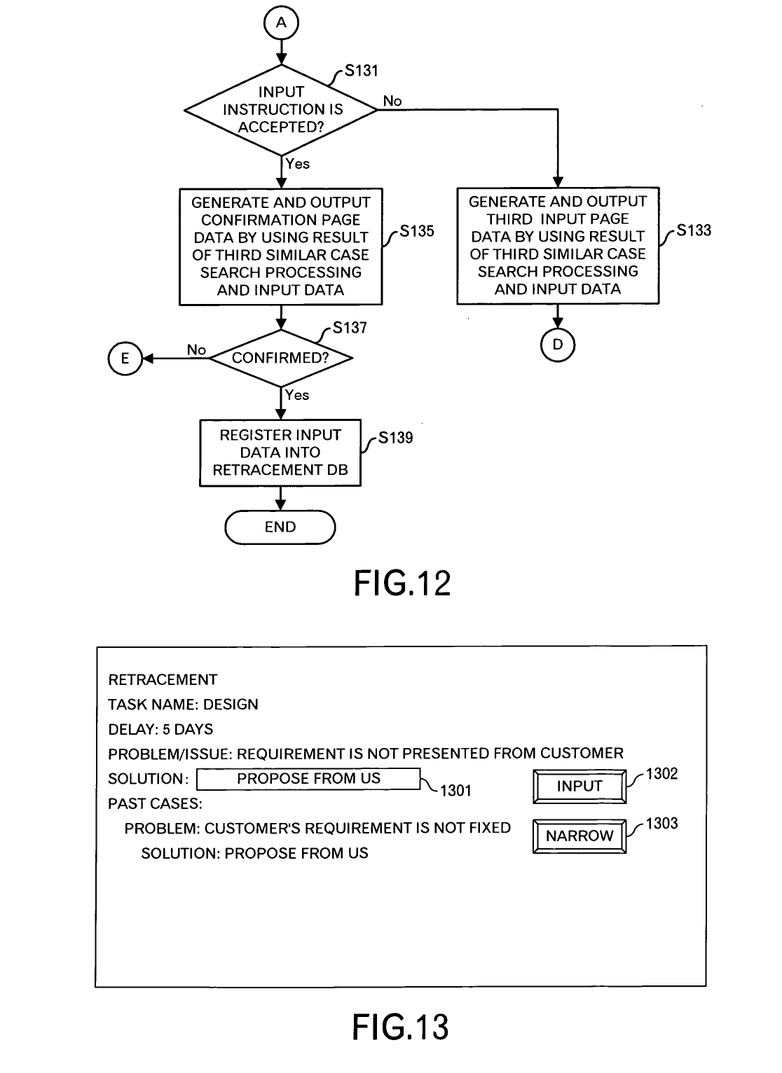

The retracement data generating processor 52 narrows the cases to the top predetermined-number cases from the list as shown in FIG. 7 (step S17). The predetermined number may be different from that in the step S5, S11 or S17. After that, the processing shifts to a processing of FIG. 12 via a terminal A.

The retracement data generating processor 52 judges whether the input button 902 on the screen shown in FIG. 10 is clicked to instruct the input, or the narrow button 903 is clicked to instruct the narrowing (step S131).

When the narrowing is instructed (step S131: No route), the retracement data generating processor 52 generates third input page data by using the result of the third similar case search processing and the input data (data relating to the problem/issue, and data relating to the solution/improvement plan), and transmits the third input page data to the user terminal A (step S133).

The user terminal A receives the third input page data from the retracement processing apparatus 5, and displays it on the display device. For example, when an input “propose from us” is carried out and the narrow button 903 is clicked, a screen as shown in FIG. 13 is displayed on the display device, for example. In the example of FIG. 13, data of a case whose case ID is A, which is stored in the retracement DB 53 shown in FIG. 3, is identified at the step S17, and its problem/issue and solution/improvement plan are included in the “past cases”. In addition, an input column 1301 of the solution/improvement plan, into which “propose from us” inputted into the input column 901 on the screen of FIG. 10 is embedded, an input button 1302, and a narrow button 1303 are provided.

While referring to the narrowed “past cases”, the user A can change the input content. Then, he or she clicks the input button 1302 or the narrow button 1303 to instruct the user terminal A to transmit the input data to the retracement processing apparatus 5. The user terminal A accepts the input from the user A, and transmits the data relating to the solution/improvement plan according to the instruction to the retracement processing apparatus 5. The processing returns to the step S14 of FIG. 4 via a terminal D.

On the other hand, when the input is instructed (step S131: Yes route), the retracement data generating processor 52 generates confirmation page data by using the result of the third similar case search processing and the input data (the data relating to the problem/issue and the data relating to the solution/improvement plan) and transmits it to the user terminal A (step S135).

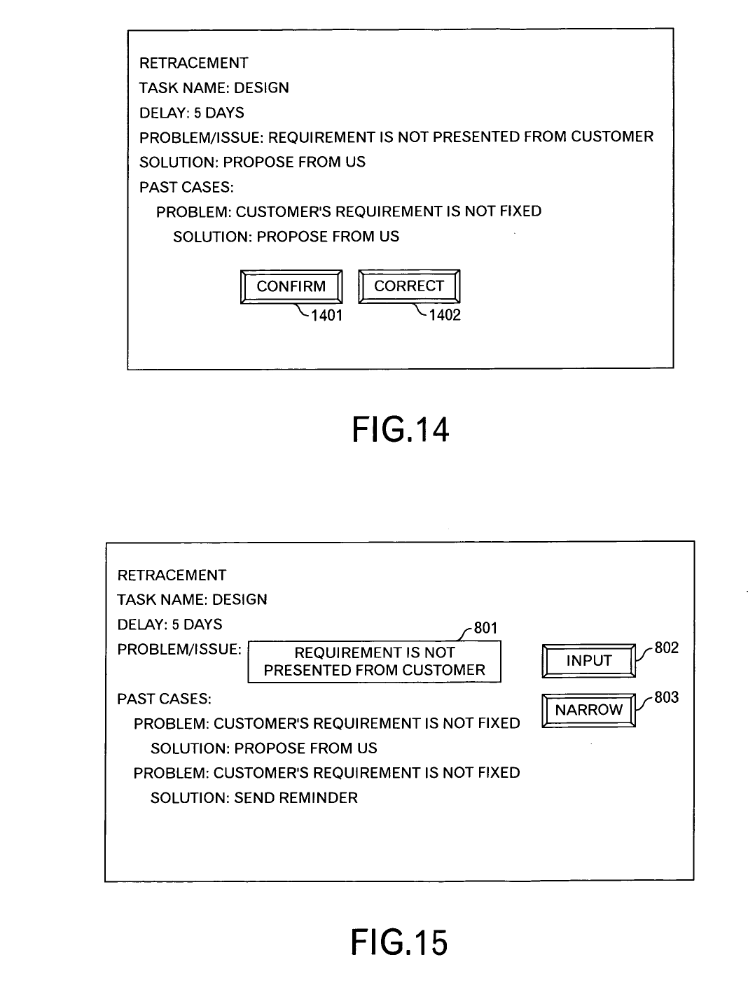

The user terminal A receives the confirmation page data from the retracement processing apparatus 5, and displays it on the display device. For example, a screen as shown in FIG. 14 is displayed on the display device. In the example of FIG. 14, the input data (“any requirement is not provided from customers” and “propose from us”) is displayed, and data of a case whose case ID of the case, which is stored in the retracement DB 53 shown in Fig. is A, is identified at the step S17 as the “past cases”. Furthermore, a confirm button 1401 and a correct button 1402 are provided, and when registering as it is, the confirm button 1401 is clicked, and when the input is corrected, the correct button 1402 is clicked. The user terminal A accepts the instruction input from the user, and transmits data relating to the instruction to the retracement processing apparatus 5.

The retracement data generating processor 52 of the retracement processing apparatus 5 receives the data relating to the instruction from the user terminal A, and judges whether or not the confirmation is instructed or not (step S137). When the correction was instructed (step S137: No route), the processing returns to the step S7 of FIG. 4 via a terminal E. However, when the categorization is carried out into a case where the problem/issue is corrected and a case where the solution/improvement plan is corrected, it is possible to ask the user A again, and to return to the step S13 when the latter case is adopted.

On the other hand, when the confirmation instruction was carried out (step S137: Yes route), the retracement data generating processor 52 registers data obtained at the step S1 and the input data received at the steps S8 and S14 into the retracement DB 53 (step S139) That is, one record is added in the data shown in FIG. 3.

When the processing as described above is carried out, while retracing the past cases, the user can input the problem/issue and the solution/improvement plan for this task, carry out the reflection and utilize the experience in the subsequent actions. That is, the similar failure can be prevented. In addition, the knowledge, which can be utilized by other users in future, can be accumulated.

As described above, although one embodiment of this invention was described, this invention is not limited to this embodiment. Specifically, the functional block diagram shown in FIG. 1 is mere an example, and it does not always correspond to the program module configuration.

Moreover, when the solution/improvement plan is inputted, the input button 1401 and the correct button 1402 are provided, and when the problem/issue is inputted, only the input button 801 is provided in FIG. 8. However, as indicated in FIG. 15, the narrow button 803 can be provided. When the narrow button 803 is clicked, the “past cases” are narrowed by the second similar case search processing that is carried out based on the data inputted in the input column 801, and the screen as shown in FIG. 15 is displayed, for example.

In addition, although the example using TF-IDF was indicated, it is possible to calculate the word-based similarity by using other techniques.

Furthermore, although the application example to the projects of the system development was explained, this invention can be applied to projects of a hardware development or architectural projects. In an example of a storage system development, instead of the type of business, it is necessary to manage data of types such as a drive, controller, cabinet, and firmware. Moreover, in a case of the architectural project, it is necessary to manage data of the type of building such as a residence, office building, and bridge.

Furthermore, according to each case, the definition of the levels, the definition of the sections, the settings of the thresholds are adjusted. Therefore, the aforementioned example is mere an example.

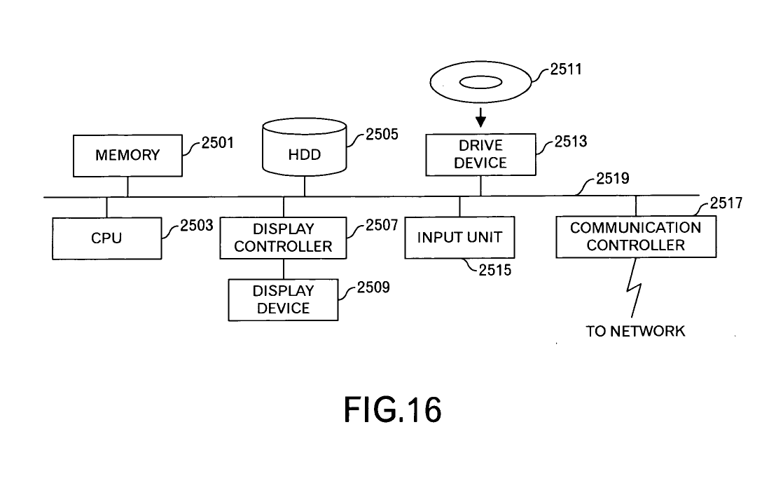

Incidentally, the user terminal, the progress management apparatus 3, and the retracement processing apparatus 5 are computer devices as shown in FIG. 16. That is, a memory 2501 (storage device), a CPU 2503 (processor), a hard disk drive (HDD) 2505, a display controller 2507 connected to a display device 2509, a drive device 2513 for a removal disk 2511, an input device 2515, and a communication controller 2517 for connection with a network are connected through a bus 2519 as shown in FIG. 28. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this invention, the application program to realize the aforementioned functions is stored in the removal disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application program are systematically cooperated with each other, so that various functions as described above in details are realized.

Although the present invention has been described with respect to a specific preferred embodiment thereof, various change and modifications may be suggested to one skilled in the art, and it is intended that the present invention encompass such changes and modifications as fall within the scope of the appended claims.

What is claimed is:

1. A retracement data processing method, comprising:
obtaining project data including a target type of a project, data concerning a scale of said project, and a pertinent phase of said project;
calculating an overall similarity for retracement data of each past project, which is stored in a retracement data storage storing a target type of a past project, data concerning a scale of said past project, a specific phase of said past project, data concerning a problem in said specific phase of said past project, and data concerning an action against a problem in said specific phase of said past project, by using a first similarity against said target type of said project, a second similarity against said data concerning said scale of said project, and a third similarity against said phase of said project; and
reading out, based on said overall similarity, from said retracement data storage, said data concerning said problem in said specific phase of said past project, or said data concerning said problem in said specific phase of said past project and said data concerning said action against said problem in said specific phase of said past project.

2. The retracement data processing method as set forth in claim 1, further comprising:
obtaining data concerning a problem in said pertinent phase of said project;
calculating a fourth similarity against said data concerning said problem in said pertinent phase of said project for said retracement data of said past project, which is stored in the retracement data storage, and modifying said overall similarity by using said fourth similarity; and
reading out, based on the modified overall similarity, from said retracement data storage, said data concerning said action against said problem in said specific phase of said past project, or said data concerning said action against said problem in said specific phase of said past project and said data concerning said problem in said specific phase of said past project.

3. The retracement data processing method as set forth in claim 2, further comprising:
obtaining data concerning an action against a problem in said pertinent phase of said project;
calculating a fifth similarity against said data concerning said action against said problem in said pertinent phase of said project for said retracement data of said past project, which is stored in the retracement data storage, and modifying said overall similarity by using said fifth similarity;
reading out, based on the modified overall similarity, from said retracement data storage, said data concerning said action against said problem in said specific phase of said past project, or said data concerning said action against said problem in said specific phase of said past project and said data concerning said problem in said specific phase of said past project.

4. The retracement data processing method as set forth in claim 1, further comprising:
obtaining at least one of data concerning a delay of a schedule, data concerning a package program utilized in a system development, data concerning a hardware utilized in said system development, and data concerning an operating system utilized in said system development, and
wherein, in said calculating said overall similarity, at least one of a similarity against said data concerning said delay of said schedule, a similarity against said data concerning said package program utilized in said system development, a similarity against said data concerning said hardware utilized in said system development, and a similarity against said data concerning said operating system utilized in said system development is further utilized.

5. The retracement data processing method as set fort in claim 1, wherein said second similarity against said data concerning said scale of said project is identified by judging whether or not a class corresponding to said data concerning said scale of said project coincides with a class corresponding to said data concerning said scale of said past project, and said third similarity against said pertinent phase of the project are identified by judging whether or not a class corresponding to said pertinent phase of said project coincides with a class corresponding to said pertinent phase of said past project.

6. The retracement data processing method as set forth in claim 2, wherein said modifying by using said fourth similarity comprises:
generating a first vector concerning words appeared in said data concerning said problem in said pertinent phase of said project;
generating a second vector concerning words appeared in said data concerning said problem in said specific phase of said past project; and
calculating a similarity based on an inner-product of said first and second vectors by using said first and second generated vectors.

7. The retracement data processing method as set forth in claim 3, wherein said modifying by using said fifth similarity comprises:
generating a third vector concerning words appeared in said data concerning said action against said problem in said pertinent phase of said project;
generating a fourth vector concerning words appeared in said data concerning said action against said problem in said specific phase of said past project; and
calculating a similarity based on an inner-product of said third and fourth vectors by using said third and fourth generated vectors.

8. The retracement data processing method as set forth in claim 1, further comprising:
obtaining data concerning a problem in said pertinent phase of said project;
calculating a second overall similarity for said retracement data of each said past project, which is stored in said retracement data storage, by using a first similarity against said target type of said project, a second similarity against said data concerning said scale of said project, and a third similarity against said phase of said project, and a fourth similarity against said data concerning said problem in said pertinent phase of said project; and
reading out, based on said second overall similarity, from said retracement data storage, said data concerning said action against said problem in said specific phase of said past project, or said data concerning said action against said problem in said specific phase of said past project and said data concerning said problem in said specific phase of said past project.

9. The retracement data processing method as set forth in claim 8, further comprising:
obtaining data concerning an action against a problem in said pertinent phase of said project;
calculating a third overall similarity for said retracement data of each said past project, which is stored in said retracement data storage, by using a first similarity against said target type of said project, a second similarity against said data concerning said scale of said project, and a third similarity against said phase of said project, a fourth similarity against said data concerning said problem in said pertinent phase of said project, and a fifth similarity against said data concerning said action against said problem in said pertinent phase of said project; and
reading out, based on said fifth overall similarity, from said retracement data storage, said data concerning said action against said problem in said specific phase of said past project, or said data concerning said action against said problem in said specific phase of said past project and said data concerning said problem in said specific phase of said past project.

10. The retracement data processing method as set forth in claim 3, further comprising: storing obtained data into said retracement data storage.

11. A program embodied on a medium, said program comprising:
obtaining project data including a target type of a project, data concerning a scale of said project, and a pertinent phase of said project;
calculating an overall similarity for retracement data of each past project, which is stored in a retracement data storage storing a target type of a past project, data concerning a scale of said past project, a specific phase of said past project, data concerning a problem in said specific phase of said past project, and data concerning an action against a problem in said specific phase of said past project, by using a first similarity against said target type of said project, a second similarity against said data concerning said scale of said project, and a third similarity against said phase of said project; and
reading out, based on said overall similarity, from said retracement data storage, said data concerning said problem in said specific phase of said past project, or said data concerning said problem in said specific phase of said past project and said data concerning said action against said problem in said specific phase of said past project.

12. The program as set forth in claim 11, further comprising:
obtaining data concerning a problem in said pertinent phase of said project;
calculating a fourth similarity against said data concerning said problem in said pertinent phase of said project for said retracement data of said past project, which is stored in the retracement data storage, and modifying said overall similarity by using said fourth similarity; and
reading out, based on the modified overall similarity, from said retracement data storage, said data concerning said action against said problem in said specific phase of said past project, or said data concerning said action against said problem in said specific phase of said past project and said data concerning said problem in said specific phase of said past project.

13. The program as set forth in claim 12, further comprising:
obtaining data concerning an action against a problem in said pertinent phase of said project;
calculating a fifth similarity against said data concerning said action against said problem in said pertinent phase of said project for said retracement data of said past project, which is stored in the retracement data storage, and modifying said overall similarity by using said fifth similarity;
reading out, based on the modified overall similarity, from said retracement data storage, said data concerning said action against said problem in said specific phase of said past project, or said data concerning said action against said problem in said specific phase of said past project and said data concerning said problem in said specific phase of said past project.

14. A retracement data processing apparatus, comprising:
a retracement data storage storing a target type of a past project, data concerning a scale of said past project, a specific phase of said past project, data concerning a problem in said specific phase of said past project, and data concerning an action against a problem in said specific phase of said past project;
a unit that obtains project data including a target type of a project, data concerning a scale of said project, and a pertinent phase of said project;
a unit that calculates an overall similarity for retracement data of each past project, which is stored in the retracement data storage, by using a first similarity against said target type of said project, a second similarity against said data concerning said scale of said project, and a third similarity against said phase of said project; and
a unit that reads out, based on said overall similarity, from said retracement data storage, said data concerning said problem in said specific phase of said past project, or said data concerning said problem in said specific phase of said past project and said data concerning said action against said problem in said specific phase of said past project.

15. The retracement data processing apparatus as set forth in claim 14, further comprising:
a unit that obtains data concerning a problem in said pertinent phase of said project;
a unit that calculates a fourth similarity against said data concerning said problem in said pertinent phase of said project for said retracement data of said past project, which is stored in the retracement data storage, and modifying said overall similarity by using said fourth similarity; and
a unit that reads out, based on the modified overall similarity, from said retracement data storage, said data concerning said action against said problem in said specific phase of said past project, or said data concerning said action against said problem in said specific phase of said past project and said data concerning said problem in said specific phase of said past project.

16. The retracement data processing apparatus as set forth in claim 15, further comprising:
a unit that obtains data concerning an action against a problem in said pertinent phase of said project;
a unit that calculates a fifth similarity against said data concerning said action against said problem in said pertinent phase of said project for said retracement data of said past project, which is stored in the retracement data storage, and modifying said overall similarity by using said fifth similarity;
a unit that reads out, based on the modified overall similarity, from said retracement data storage, said data concerning said action against said problem in said specific phase of said past project, or said data concerning said action against said problem in said specific phase of said past project and said data concerning said problem in said specific phase of said past project.
